(19) United States
(12) Patent Application Publication
(10) Pub. No.: US 2012/0050034 A1
(43) Pub. Date: Mar. 1, 2012

(54) Digital Event Notification System

(76) Inventor: Karen Hushek, Morrisville, NC (US)

(21) Appl. No.: 13/154,344

(22) Filed: Jun. 6, 2011

Related U.S. Application Data
(60) Provisional application No. 61/376,367, filed on Aug. 24, 2010.

(51) Int. Cl. G08B 1/08

(52) U.S. Cl. 340/539.13

(57) ABSTRACT

An event-paging device and method designed for use by elderly individuals in community settings. The device receives transmissions from a central system and provides notification to the user of individual or group events. The device is equipped with a digital display screen, upon which the user may read the transmitted details of the event. Further, the device is equipped with buttons to respond or indicate distress, as well as a means by which the central system may determine the location of the user, such as GPS tracking. Events such as meals or broad notifications may be sent out system wide, while individual events such as medication times or appointments may be sent to specific groups or individuals.

### CROSS REFERENCE TO RELATED APPLICATION

This application claims the benefit of U.S. Provisional Application No. 61/376,367 filed on Aug. 24, 2010, entitled “Digital Event Notification Device.”

### BACKGROUND OF THE INVENTION

1. Field of the Invention

The present invention relates to a digital event notification system for elderly individuals in group homes, allowing staff to communicate reminders and scheduling information.

Our aging population, through improved health care, has created a demand for technologies allowing older persons to live independent lives, even in group living situations. One particular issue is reminding seniors of important events and happenings to which they must attend. Typically, in a group living situation, a nurse or attendant will have to remind each person of an event. Other alternatives bear examination.

Various means exist for contacting people remotely. For example, wireless wide-area pagers may be used to provide the recipient with a telephone number for calling back, or with some other type of notice. However, not many individuals use dedicated pagers, and it would be impracticable for busy nurses and attendants to keep track of individual and group events on a piecemeal basis. While the popularity of traditional pagers is certainly waning (e.g., those with one-way numerical messaging), most people now carry mobile phones, wireless personal digital assistants (PDAs) or other wireless terminals for voice or data contact. This is not however, the case with many seniors, who may not adapt to using such recent technology. Additionally, it is not practical for busy nurses or attendants to take note of an individual's mobile phone number and then manually call or message the patron to remind them of individual events. Further, in a group living situation, reminders for daily group events such as lunch or dinner would require dozens or even hundreds of individual phone calls.

Further, for seniors who may have issues with hearing or sight, multiple means of notification are necessary. Audible notifications are advantageous since they can provide the user with notification of the event without the communications device being in immediate proximity to the user. Tactile notifications are also advantageous since they can provide notification of the event without disturbing individuals nearby, or if the individual suffers from hearing loss. Consequently there is a need for a device with the capability to notify the user of an event through audible means, tactile means, visible means or a combination thereof.

Such notifications are particularly relevant in senior citizen retirement communities. Many retirement communities and nursing homes offer a full daily schedule of activities and meals. It can be particularly difficult for residents to remember when and where these events take place. Although the schedule can be in printed form, many of the residents may lose track of the day, time, and place of each scheduled event. As such, they have a tendency to repeatedly question the staff regarding when their next meal is or what activity is happening next. In such instances, the staff may become overburdened. Residents may be more likely to participate if they know where they are supposed to be. An improved method of notifying a large population of both personal and group events is needed. The present invention fulfils this need.

2. Description of the Prior Art

Several different issued U.S. Patents and published applications address issues related to an event paging and monitoring system for the elderly. These prior art fail to address the fundamental issues of the present invention.

Tarallo U.S. Patent Publication No. 2006/0258334 is directed to a wireless paging system allows a business to automatically page customers via the customers' mobile phones or other wireless devices, using an existing cellular telecommunications network. The paging system includes a local, Internet-connected computer deployed at the business and a notification and scheduling program. The notification program is interfaced with the cellular network's short messaging service or the like, through the Internet or otherwise. If a customer has to wait upon arrival for a product and/or service, the customer's mobile phone number is entered into the notification program. Upon receiving data indicating that the product and/or service has become available, the notification program generates a notification message sent to the customer's wireless device. The Tarallo invention is designed for use in a place of business covers small areas and does not communicate with the customer beyond serving to summon them when their product or service is available.

MacFarlane U.S. Patent Publication No. 2009/0219166 is directed to a method of event notification on a handheld communications device involving first receiving an indication of an occurrence of an event at the handheld communications device. The communications device comprises a display, and the event has an associated visual notification. The visual notification provides particulars of the event. The MacFarlane invention is a method of using a telephone communications device to receive details regarding events. The elderly do not necessarily want to be burdened with having to carry a cellular telephone, and often do not understand their use. The present invention is designed to be simple, and convey information to and from the user with a minimum of technical prowess.

DeLuca U.S. Pat. No. 4,872,005 is directed to an electronic paging receiver for reminding a user of an important event. The paging receiver computes an alert time to remind the user of the receipt of the data message. Additionally, the user may enter a future alert. Further, the paging receiver is capable of detecting a special time/date field in the received data message to generate a future alert. The DeLuca invention describes a method of determining reminders for page recipients. While useful it its own right, the DeLuca invention does not address the issue of sending pages to individuals or groups to remind them of events.

Petelenze U.S. Pat. No. 6,422,690 is directed to a method and system for recording acceleration and body position data from elderly or disabled persons. The fall monitoring system includes signal feature methods for characterizing accelerations and body positions during fall events. The system can detect health and life threatening fall events in elderly persons, and can autonomously notify nursing personnel or family members that the person is in need of immediate assistance. The Petelenze method and system are for monitoring the health and well-being of patients. While the Petelenze system addresses a critical issue, it does not attempt to address any issues related to scheduling or reminders.

Wicks U.S. Pat. No. 6,624,746 is directed to a pager and system adapted to provide music enthusiasts with generally available information regarding musical events. A subscriber of the musical information service provides the service provider with an interest profile detailing the subscriber's musical interests. The provider compiles information regarding events, compares the information to the profile, and transmits information matching the profile to the subscriber's pager. The system may also determine the pager's general location and provide information relevant to that locale. The Wicks invention transmits information to selected individuals who have signed up for a music notification service. While the device does serve to remind the user of important events, there is no interaction with the central service, and beyond user preferences and locale, there is no tailoring of the events to the individual. These issues are both addressed by the present invention.

Nickum U.S. Pat. No. 6,934,955 is directed to an event notification system. The system comprises a computer having a CPU and memory and which runs programs to generate events. The invention further comprises a notification controller to detect the generated events, a notification transceiver capable of transmitting a message containing data on the event, and a portable transceiver including a notifier for receiving the message. The Nickum patent describes the transmission of computer-generated events, particularly useful for those monitoring servers or other important computer systems. However, the Nickum patent does not address the issues of user created and tailored events.

While patents have been issued and applications published for event paging systems, there is no device in the prior art that suitably addresses the notification needs of a small community, such as a retirement community. The prior art patents do not allow central users, such as nurses and staff to customize events. Nor do they allow user interaction with the device, as in the present invention. Further, they do not address the need to locate and assist an elderly individual when necessary. For these reason, the present invention substantially diverges from the prior art and fulfills a long felt need.

### SUMMARY OF THE INVENTION

In view of the foregoing disadvantages inherent in the known types of event pager devices and systems now present in the prior art, the present invention provides a new digital event notification device wherein the same can be utilized for providing convenience for the user when providing reminders for individuals regarding events, medications and schedules.

The present invention is a small electronic device and method designed to alert senior citizens in residential care facilities and retirement communities of the day's activities. The device is worn around the neck or wrist, and apprises residents of times, locations and descriptions of upcoming events or those that are currently taking place. Reminding elderly residents of events encourages them to be active, get out of their rooms and participate in the various activities. Such activity and socialization increases mobility and social interaction, which are extremely valuable to seniors. The present invention assists the care staff by enabling the residents to report to meals and other events without the need for individual attention or assistance. Visual and vibration based reminders make the present invention ideal for use by those that are hearing or visually impaired.

The present invention provides individuals with specific information regarding their daily activities and events. This electronic device should be small and lightweight, such that it is attachable to a necklace chain or wristband. The device may have a display screen that can display the day's events, times, and locations. This information downloads from the facility's master calendar using a wireless network or cellular phone technology. The display screen may constantly display the current date and time for the benefit of the practitioner. The device may illuminate, vibrate or produce an audible sound when it is time for an event. It may also have a communication system and integrated speaker for audible announcement the event. The unit may also include a GPS tracking device, an assistance call button, and a medication alert. The device may have ports to connect it to a computer, phone, or other electronic device for downloading, syncing and communication purposes. The device may also be available in various shapes, sizes, and colors to suit the tastes or needs of the user.

It is therefore an object of the present invention to provide a communications device to wear around the practitioner's wrist or neck, or for storage in a pocket or purse. It is a further object of the present invention to receive communications of events from a central system that provide times, locations and descriptions for the user. The device reminds the user through various alert means of events they must attend, such as meals or medication times. It also alerts the user of current events and activities within the community that may be of interest.

Another object of the present invention is to provide a communication device and method that is easy to use and operates largely independent of user interaction, receiving signals over a wireless or cellular network. The invention has a screen large enough to accommodate those with impaired vision, and is designed in a variety of colors and styles to suit user preferences.

Yet another object of the present invention is to provide a two way communication system and method, by which the user can respond back the central system regarding attendance of events or summon assistance if needed. It is a further object of the present invention that the device should track the location of the user, so that the operators of the system may locate the wearer should an emergency arise.

Other objects, features and advantages of the present invention will become apparent from the following detailed description taken in conjunction with the accompanying drawings.

### BRIEF DESCRIPTIONS OF THE DRAWINGS

FIG. 1 is a perspective view of a wrist embodiment of the present invention, further demonstrating the vibrating function as a means of informing the bearer of an imminent event.

FIG. 2 is a perspective view of a neck embodiment of the present invention, further demonstrating the vibrating function as a means of informing the bearer of an imminent event.

FIG. 3 demonstrates perspective views three cosmetically different embodiments of the present invention.

### DETAILED DESCRIPTION OF THE INVENTION

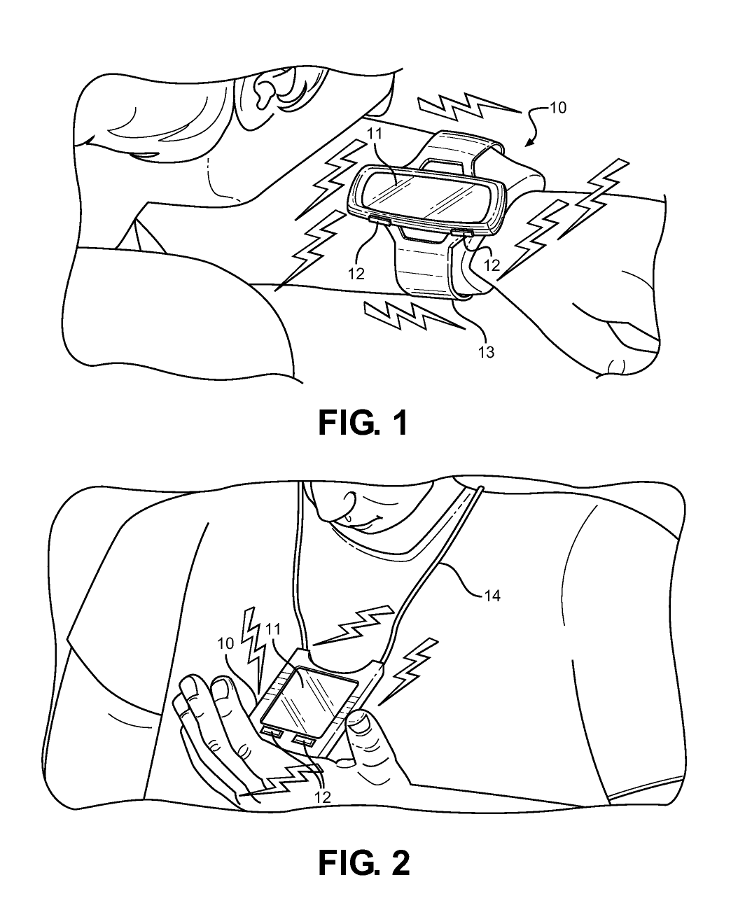

Referring now to FIG. 1, there is shown a perspective view of a wrist embodiment of the present invention, further demonstrating the vibratory function as a means of informing the wearer of an imminent event. The communications device 10 has a digital display screen 11, capable of displaying messages regarding events sent from a central system via wireless or cellular communications. Further, the device 10 has one or a plurality of buttons 12, allowing communication from the user to be sent back to the central system. One embodiment of the device features a wrist strap 13, allowing it to be worn on a user's arm.

Referring now to FIG. 2, there is shown a perspective view of a neck embodiment of the present invention, further demonstrating the vibratory function as a means of informing the bearer of an imminent event. The neck embodiment of the device 10 has similar functionality as the wrist embodiment, save for the shape and neck strap 14. The device 10 has a digital display screen 11, as well as one or a plurality of buttons 12 allowing the user to send communications back to the central system.

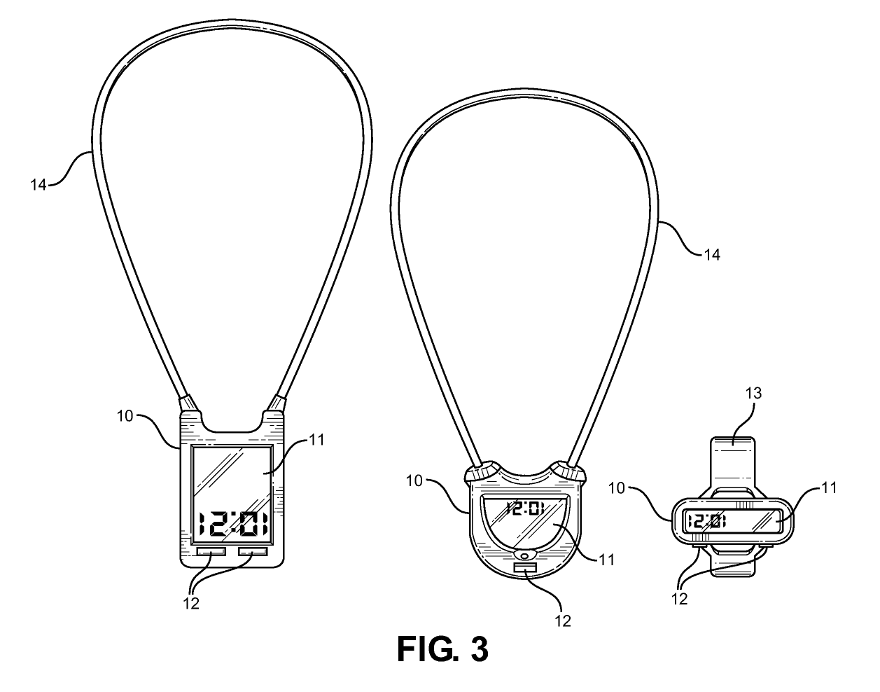

Referring now to FIG. 3, there is shown perspective views of three cosmetically different embodiments of the present invention. Each embodiment has generally the same structure 10, namely an enclosure for imbedded electronics, a digital screen 11, a plurality of buttons 12 for interaction, and a means for attaching to the user. The means contemplated for attachment to the user include a neck strap 14 or a wrist strap 13.

The present invention provides individuals with specific information regarding their daily activities and events. The device 10 is small and lightweight so it can easily be carried on the wrist, neck or in a pocket or bag. It may be attached to a neck strap 14 or wrist strap 13. The device has a digital display screen 11 that displays the day's events, times, and locations. This information may be downloaded and synced from the facility's master calendar using a wireless network or cellular phone technology. The digital display screen 11 may constantly display the current date and time for user convenience. Further, device 10 may illuminate or vibrate to signal that an event is upcoming or that an event has been scheduled. Further, the device may also have an intercom or other communication system and integrated speaker to announce events. The device 10 may also include an imbedded GPS tracking device, along with an assistance call button or other input buttons 12, and a medication alert notification. The device may 10 include ports to connect it to a computer, phone, or other electronic device for downloading and syncing purposes. The device 10 may be available in various shapes, sizes, and colors to suit user preferences or needs.

In use, an elderly or other individual in need of reminders will be equipped with the present invention. A central communication system is used to coordinate events, and when appropriate send out a reminder to those with a device. The central communication system will be equipped to send events and reminders to all devices 10 in the network, groups of devices 10 in the network or to single devices 10 in the network. Thus, nurses at the facility can send medication messages to specific individuals or send reminders to everyone regarding the start of an event or activity. Upon receiving a scheduled event, the device 10 will notify the user via an audible, tactile (vibratory) or visual cue that there is an event. Additionally, the event details will display on the digital display screen 11. Further, the user may signal their attendance with the push of a button 12. Additionally, the device may be equipped with a button to summon assistance 12.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A event notification system, comprising:
a notification sending and receiving device;
said device adapted to be worn by the user;
one or a plurality of buttons allowing user input to said receiving device;
said device adapted to receive and transmit communication to and from a central system for events and related event details such as time, location and description;
a digital display screen on said receiving device upon which said event and details are displayed;
and audible, tactile and visual notification means for signaling said event;
an imbedded GPS tracking means within said receiving device.

2) A device as in claim 1, further comprising an emergency distress button that notifies a central system that a user is in distress and requires immediate assistance.

3) A device as in claim 1, further comprising a neck-worn lanyard attachable to said receiving device.

4) A device as in claim 1, further comprising a wristband attachable to said receiving device.

5) A method of notifying individuals or groups of individuals, comprising the steps of:
transmitting events and related event details such as time, location and description from a central system to a receiving device,
said receiving device is worn by an individual and alerts said individual of an event via auditory, tactile or visual means,
displaying said event details on said receiving device screen,
providing feedback from said receiving device to inform said central system of attendance for an event, alerting said central system of an emergency, or tracking said receiving device based on user location.
